(19) United States
(12) Patent Application Publication
(10) Pub. No.: US 2020/0386782 A1
(43) Pub. Date: Dec. 10, 2020

(54) APPARATUS AND METHOD FOR CALIBRATING INERTIAL MEASURING UNIT

(71) Applicant: SK TELECOM CO., LTD., Seoul (KR)

(72) Inventor: Seongsoo LEE, Seoul (KR)

(21) Appl. No.: 16/892,948

(22) Filed: Jun. 4, 2020

(30) Foreign Application Priority Data
Jun. 5, 2019 (KR) 10-2019-0066616

(51) Int. Cl. G01P 21/00; G01C 25/00

(52) U.S. Cl. CPC G01P 21/00; G01C 25/005

(57) ABSTRACT

In accordance with an aspect of the present disclosure, there is provided a method for calibrating an inertial measuring unit (IMU), the method comprises, estimating a height direction (z-axis) vector of a vehicle based on data measured, while the vehicle is stopped, by the inertial measuring unit mounted on the vehicle, estimating a vector parallel to a plane including a moving direction (x-axis) vector and the estimated height direction vector of the vehicle based on data measured, while the vehicle is moving straight, by the inertial measuring unit, estimating a width direction (y-axis) vector of the vehicle based on the estimated height direction vector and the vector estimated to be parallel to the plane, and calculating a rotation transformation matrix of the inertial measuring unit on the basis of a coordinate system of the vehicle, using the estimated height direction vector and the estimated width direction vector.

### CROSS-REFERENCE TO RELATED APPLICATION

This application claims priority to Republic of Korea Patent Application No. 10-2019-0066616, filed on Jun. 5, 2019, the entire contents of which are incorporated herein by reference.

### TECHNICAL FIELD

The present disclosure relates to an apparatus and method for calibrating an inertial measuring unit.

### BACKGROUND

In general, a vehicle means a transportation apparatus that runs on a road or a track using fossil fuels, electricity, etc. as a power source.

The vehicle has been developed to provide various functions to a driver according to the development of technology. Particularly, according to the trend of vehicle electrification, the vehicle having an active safety system (ASS), which operates to prevent an accident immediately before or at the time of an accident, has appeared.

Furthermore, recently, research is actively conducted on the vehicles equipped with an advanced driver assist system (ADAS) which actively provides information about a driving environment, such as vehicle condition, driver condition, and surrounding environment, in order to alleviate the burden on the driver and enhance convenience.

The advanced driver assist system may include a sensing means to detect the driving environment, and may include an inertial measuring unit (IMU) as an example of the sensing means. The inertial measuring unit is installed in the vehicle, and may include a gyroscope, an acceleration sensor, a geomagnetic sensor, etc.

Here, calibration must be performed between the inertial measuring unit and the vehicle to estimate external parameters. For example, in order that data measured by the inertial measuring unit is used to sense the driving environment, information about a rotation transformation matrix or a movement transformation matrix between a vehicle coordinate system and an inertial measuring unit coordinate system is required.

### SUMMARY

According to embodiments of the present disclosure, a technology for performing calibration between an inertial measuring unit and a vehicle is provided.

In accordance with an aspect of the present disclosure, there is provided a method for calibrating an inertial measuring unit (IMU), the method comprises, estimating a height direction (z-axis) vector of a vehicle based on data measured, while the vehicle is stopped, by the inertial measuring unit mounted on the vehicle, estimating a vector parallel to a plane including a moving direction (x-axis) vector and the estimated height direction vector of the vehicle based on data measured, while the vehicle is moving straight, by the inertial measuring unit, estimating a width direction (y-axis) vector of the vehicle based on the estimated height direction vector and the vector estimated to be parallel to the plane, and calculating a rotation transformation matrix of the inertial measuring unit on the basis of a coordinate system of the vehicle, using the estimated height direction vector and the estimated width direction vector.

In accordance with another aspect of the present disclosure, there is provided a calibration apparatus for calibrating an inertial measuring unit (IMU) mounted on a vehicle, the calibration apparatus comprises a control unit configured to, estimate a height direction (z-axis) vector of the vehicle based on data measured, while the vehicle is stopped, by the inertial measuring unit, estimate a vector parallel to a plane including a moving direction (x-axis) vector and the estimated height direction vector of the vehicle based on data measured, while the vehicle is moving straight, by the inertial measuring unit, estimate a width direction (y-axis) vector of the vehicle based on the estimated height direction vector and the vector estimated to be parallel to the plane, and calculate a rotation transformation matrix of the inertial measuring unit on the basis of a coordinate system of the vehicle, using the estimated height direction vector and the estimated width direction vector.

According to an embodiment of the present disclosure, the calibration apparatus can calibrate an inertial measuring unit in an online manner without a separate external apparatus in an environment in which a vehicle V actually runs on a road. Accordingly, it is possible to simplify and reduce a calibration process for an ADAS applying the inertial measuring unit 300 and an autonomous vehicle.

### BRIEF DESCRIPTION OF THE DRAWINGS

FIG. 1 is a conceptual diagram conceptually showing that a calibration apparatus according to an embodiment is employed in a vehicle.

FIG. 2 is a schematic conceptual diagram of an inertial measuring unit.

FIG. 3 is a schematic conceptual diagram of each of a vehicle coordinate system and an inertial measuring unit coordinate system.

FIG. 4 is a flowchart of a procedure for performing a calibration method according to an embodiment.

FIG. 5 is a detailed flowchart illustrating some of the steps shown in FIG. 4 in detail.

FIG. 6 is a detailed flowchart illustrating some of the steps shown in FIG. 4 in detail.

FIG. 7 is a detailed flowchart illustrating some of the steps shown in FIG. 4 in detail.

FIG. 8 is an exemplary distribution diagram of data collected at each of three axes by an acceleration sensor while a vehicle is moving straight.

FIG. 9 is an exemplary distribution diagram of data collected at each of three axes by an acceleration sensor while a vehicle is moving straight.

FIG. 10 is an exemplary distribution diagram of data collected at each of three axes by an acceleration sensor while a vehicle is moving straight.

FIG. 11 is an exemplary distribution diagram of data collected at each of three axes by an acceleration sensor while a vehicle is moving straight.

FIG. 12 is an exemplary distribution diagram of data collected at each of three axes by an acceleration sensor while a vehicle is moving straight.

FIG. 13 is a detailed flowchart illustrating some of the steps shown in FIG. 4 in detail.

FIG. 14 is a detailed flowchart illustrating some of the steps shown in FIG. 4 in detail.

### DETAILED DESCRIPTION

Advantages and features of the present disclosure, and methods for achieving them will become apparent with reference to embodiments described below in detail in conjunction with the accompanying drawings. However, the present disclosure is not limited to the embodiments disclosed below, but may be implemented in various different embodiments; and the embodiments disclosed herein are provided only to make the disclosure of the present disclosure complete, and only to enable those skilled in the art to fully understand the scope of the present disclosure; and the scope of the present disclosure is defined only by the claims.

In the description of embodiments according to the present disclosure, if it is determined that a detailed description of known functions or configurations may unnecessarily obscure the subject matters of the present disclosure, the detailed descriptions thereof will be omitted. In addition, terms to be described later are those defined in consideration of functions in the embodiments of the present disclosure, and may vary depending on the intention or practice of a user or operator. Therefore, the definition should be made based on the contents throughout this specification.

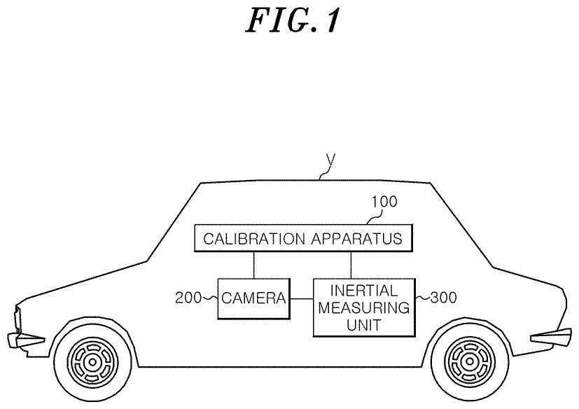

FIG. 1 is a conceptual diagram conceptually showing that a calibration apparatus 100 according to an embodiment is employed in a vehicle V. However, since FIG. 1 is merely exemplary, the calibration apparatus 100 is not interpreted as being limited to that shown in FIG. 1. Referring to FIG. 1, the calibration apparatus 100 may be mounted on the vehicle V together with a camera 200 and an inertial measuring unit 300.

The vehicle (V) may be a transportation device that can move humans, objects, animals or the like from one location to another while running along a road or track. The vehicle V may include, for example, a three-wheeled or four-wheeled vehicle, a two-wheeled vehicle such as a motorcycle, construction machinery, a motor bicycle, a bicycle, a train running on a track, etc.

The vehicle V may be equipped with an advanced driver assistance system (ADAS). Here, the advanced driver assistance system means a system that provides driving environment information such as vehicle V condition, driver condition or surrounding environment information, or actively controls the vehicle V in order to reduce a driver's burden and enhance convenience.

Such an advanced driver assistance system may include a camera 200 as a sensing means. The camera 200 may be provided to face the front, side and/or rear of the vehicle V to obtain an image in the corresponding direction. The obtained image may be a basis for obtaining information such as a lane or a sign as well as objects around the vehicle V through an image processing process.

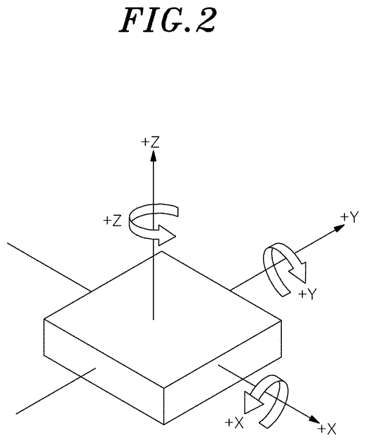

In addition, the advanced driver assistance system may include an inertial measuring unit (IMU) 300. The inertial measuring unit is configured to measure the inertia of the vehicle V. FIG. 2 conceptually shows the inertial measuring unit. Referring to FIG. 2, the inertial measuring unit 300 may include, for example, a gyroscope, an acceleration sensor and a geomagnetic sensor. However, since each of these components included in the inertial measuring unit 300 is known in the art, a description of each of these components will be omitted.

Meanwhile, the vehicle V may use various information to control the vehicle V itself. For example, the vehicle V may fuse and use image information obtained by the camera 200, or CAN data such as wheel rotation information or yaw rate information transmitted through a CAN communication method, which is a communication method between vehicle V internal modules, to control the vehicle V. Here, the image obtained by the camera 200 may be according to a camera coordinate system, while the CAN DATA may be according to a vehicle coordinate system.

The calibration apparatus 100 includes a control unit (not shown in the figure), which may be implemented by a memory storing instructions programmed to perform a function described below, and a microprocessor executing these instructions.

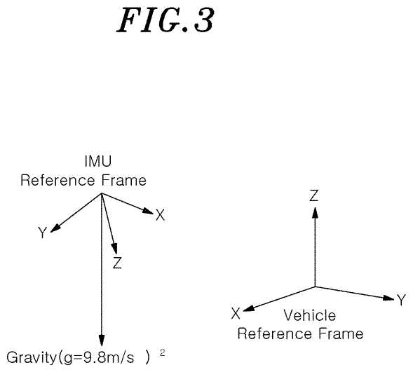

Specifically, the calibration apparatus 100 is configured to calculate a rotation transformation matrix in which an attitude angle, i.e., a mounting angle at which the inertial measuring unit 300 is mounted on the vehicle V, is calculated on the basis of a vehicle coordinate system. Here, the rotation transformation matrix refers to a rotation transformation matrix between a coordinate system based on the inertial measuring unit and a coordinate systems based on the vehicle V. FIG. 3 conceptually illustrates each of the inertial measuring unit-based coordinate system and the vehicle V-based coordinate system. Here, a x-axis direction is a moving direction vector of the vehicle V, a y-axis direction is a width direction vector of the vehicle V, and a z-axis direction is a height direction vector of the vehicle V.

Meanwhile, according to an embodiment, the calibration apparatus 100 can calibrate the inertial measuring unit 300 in an online manner without a separate external apparatus in an environment in which the vehicle V actually runs on a road. Accordingly, it is possible to simplify and reduce a calibration process for an ADAS applying the inertial measuring unit 300 and an autonomous vehicle.

Hereinafter, a method of calibrating an inertial measuring unit 300, which is performed by the calibration apparatus 100, will be described in more detail.

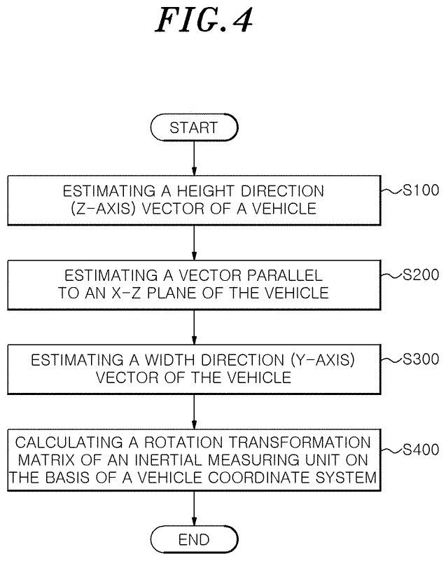

FIG. 4 is a schematic flowchart for a method of calibrating an inertial measuring unit 300 according to an embodiment. However, since the flowchart shown in FIG. 4 is merely exemplary, the spirit of the present disclosure is not interpreted as being limited to the flowchart shown in FIG. 4.

Referring to FIG. 4, step S100 is performed in which a height direction (z-axis) vector of a vehicle V is estimated based on data measured by an inertial measuring unit (IMU) 300 mounted on the vehicle V while the vehicle V is stopped.

Further, step S200 is performed in which a vector parallel to a plane (a plane consisting of x-axis and z-axis) including a moving direction (x-axis) vector of the vehicle V and the height direction vector estimated at S100 is estimated based on data measured by the inertial measuring unit 300 while the vehicle V is moving straight.

In addition, step S300 is performed in which a width direction (y-axis) vector of the vehicle V is estimated based on the height direction vector estimated at S100 and the vector estimated to be parallel to the plane estimated at S200.

Moreover, step S400 is performed in which a rotation transformation matrix of the inertial measuring unit 300 is calculated on the basis of a coordinate system of the vehicle V by using the height direction vector estimated at S100 and the width direction vector estimated at S300.

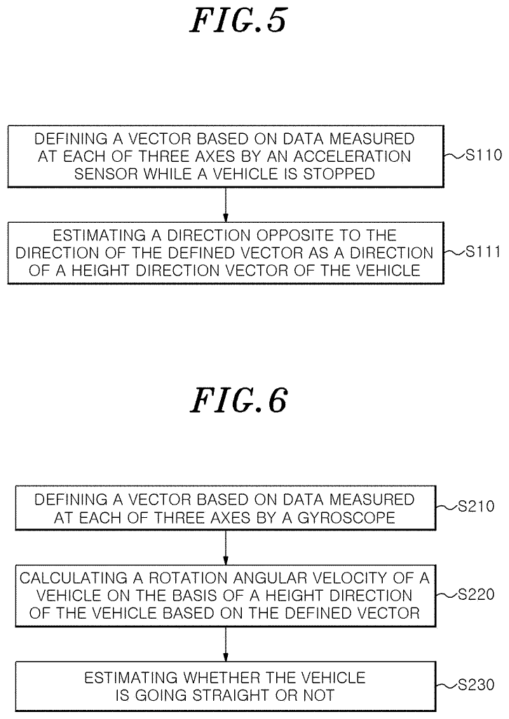

Among these steps, S100 will be described in more detail with reference to FIG. 5. FIG. 5 is a flowchart illustrating S100 in more detail.

Referring to FIG. 5, step S110 is performed in which a vector is defined based on data measured at each of three axes by an acceleration sensor of the inertial measuring unit 300 while the vehicle V is stopped. More specifically, in a situation where the vehicle V is stopped, in the case of data [aₓ, a_{y}, a_{z}] measured at each of the 3 axes by the acceleration sensor, it indicates a direction opposite to the direction of gravitational acceleration, and its magnitude returns the magnitude of the gravitational acceleration, that is, 9.8 m/s². Here, it is possible to determine whether the vehicle V is stopped or not based on whether the vehicle's wheel speed is zero.

In addition, step S111 is performed in which a direction opposite to the direction of the vector defined at S110 is estimated as a direction of a height direction vector of the vehicle V. In the case of S111, it is a step devised based on the fact that, assuming that the vehicle V is stopped on a flat ground, a direction indicated by the vector based on the above data measured at each of the three axes by the acceleration sensors indicates a direction opposite to the height direction (z-axis) of the vehicle coordinate system.

Here, noise may exist in the data measured at each of the three axes by the acceleration sensor at S110. For example, if the acceleration sensor malfunctions at a certain point in time or if an object having a mass that affects the acceleration sensor is located near the acceleration sensor at a certain point in time, a direction of the data measured by the acceleration sensor at each of the three axes may be different from the direction of gravity, and the magnitude may also be different from the magnitude of gravitational acceleration.

In order to remove this noise, according to one embodiment, the vector at S110 is not defined by acquiring only one data measured at each of the three axes by the acceleration sensor at a specific point in time, but rather the vector at S110 may be defined based on an average value obtained by acquiring a plurality of such data and calculating the average thereof.

In this case, as a method of acquiring a plurality of data, there may be a method in which one acceleration sensor is provided in the vehicle V and then the one acceleration sensor measures data at each of the three axes at a time interval, or a method in which a plurality of acceleration sensors are provided in the vehicle V and then the plurality of acceleration sensors measure data at each of the three axes at the same time or at a time interval, but is not limited thereto.

Equations 1 and 2 below exemplarily show the results derived by steps S110 and S111. Specifically, Equation 1 indicates that an average value of the data measured by N acceleration sensors at each of the 3 axes is a vector having a direction opposite to the direction of gravitational acceleration. In this regard, if the vehicle V was stopped on a flat ground, −g/|g| becomes the same as a z-axis direction of the vehicle V.

$$- g = [ \begin{matrix}- {g}_{x} \\ - {g}_{y} \\ - {g}_{z}\end{matrix} ] = \frac{1}{N} {\sum }_{i = 1}^{N} [ \begin{matrix}{a}_{x , i} \\ {a}_{y , i} \\ {a}_{z , i}\end{matrix} ] \qquad [ Equation 1 ]$$

In addition, Equation 2 indicates a unit vector representing a z-axis direction vector V_{z} of the vehicle V on the basis of a coordinate system of the inertial measuring unit.

V_{z}=−g/|g| [Equation 2]

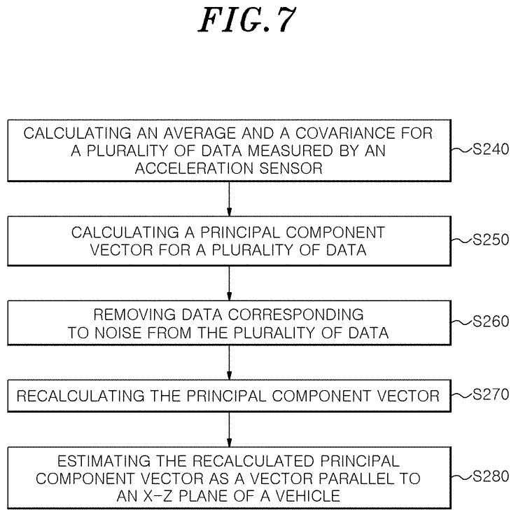

Next, the S200 shown in FIG. 4 will be described in more detail with reference to FIGS. 6 and 7.

FIG. 6 is a detailed flowchart of a process for estimating whether the vehicle V is moving straight or not among the S200 shown in FIG. 4. Referring to FIG. 6, step S210 is performed in which a vector is defined based on data measured at each of three axes by a gyroscope included in an inertial measuring unit 300. In this regard, the data measured by the gyroscope at each of the 3 axes may change slightly over time. In one embodiment, a vector can be defined by selecting only the most recent N data and then obtaining the average thereof. Equation 3 below exemplarily shows a vector defined in this way.

$${ω}_{bias} = [ \begin{matrix}{ω}_{bias \_ x} \\ {ω}_{bias \_ y} \\ {ω}_{bias \_ z}\end{matrix} ] = \frac{1}{N} {\sum }_{i = 1}^{N} [ \begin{matrix}{ω}_{x , i} \\ {ω}_{y , i} \\ {ω}_{z , i}\end{matrix} ] \qquad [ Equation 3 ]$$

Here, the defined vector W_{bias} can be used as a bias for the gyroscope.

Next, step S220 is performed in which a rotation angular velocity of the vehicle V on the basis of a height direction of the vehicle V is calculated based on the vector defined at S210. Equation 4 below exemplarily shows the rotation angular velocity of the vehicle V on the basis of the height direction of the vehicle V.

ω_{vehicle_z}=V_{z}(ω−ω_{bias}) [Equation 4]

Next, step S230 is performed in which whether the vehicle V is moving straight or not is estimated based on the rotation angular velocity calculated at S220. For example, if an absolute value of the rotation angular velocity ω_{vehicle_z} calculated at S220 is less than or equal to a predetermined threshold, it may be estimated that the vehicle V is moving straight. However, other methods are not excluded in which whether the vehicle V goes straight or not is estimated in a different manner.

FIG. 7 is a detailed flowchart of a process for estimating a vector parallel to an x-z plane of the vehicle V among S200 shown in FIG. 4. Referring to FIG. 7, an average and covariance are calculated for a plurality of data measured by an acceleration sensor at three axis (S240); a principal component vector is calculated for a plurality of data based on the calculated average and covariance (S250); based on the principal component vector calculated at S250, data corresponding to noise is removed from the plurality of data (S260); and then, the principal component vector is recalculated again for the remaining data from which the noise was removed (S270). Here, at S250, a principal component analysis (PCA) algorithm may be used to calculate the principal component vector.

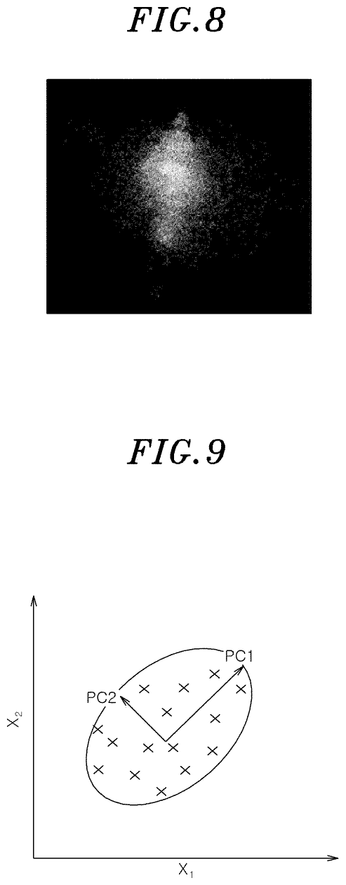

Specifically, noise may be included in the plurality of data measured at S240. FIG. 8 is a diagram exemplarily illustrating a distribution of a plurality of data including noise measured at S240.

Accordingly, according to one embodiment, in order to remove noise included in a plurality of data, an average and covariance for the plurality of data are obtained (S240); and PCA (Principal Component Analysis) is used to find a new base (axis) orthogonal to each other while preserving variance as much as possible through eigen decomposition and to find a principal component of the distributed data (S250).

For example, FIG. 9 exemplarily shows that two axes PC1 and PC2 are obtained through PCA analysis for a plurality of data.

In the PCA analysis, when the eigen decomposition is performed for a covariance matrix of the plurality of data, the eigenvector appearing at this time is a principal component vector and indicates a direction of large variance in the distribution of data, and the corresponding eigenvalue indicates a magnitude of the variance.

FIG. 10 exemplarily shows that such covariance is obtained for a plurality of data, and then a direction having the greatest variance is denoted by a red line through the eigenvalue decomposition.

In addition, Equation 5 below shows a process of obtaining a principal component vector through the eigenvalue decomposition of covariance for a plurality of data, wherein e1 is a vector that conforms to a direction of the red line shown in FIG. 10.

Cov_{3*3}=UΣU^{T} [Equation 5]

Here, e1, e2 and e3 of U=[e₁ e₂ e₃] mean eigen vectors orthogonal to each other (3×1 vectors).

$$\begin{matrix}μ = [ \begin{matrix}{μ}_{x} \\ {μ}_{y} \\ {μ}_{z}\end{matrix} ] = \frac{1}{N} {\sum }_{i = 1}^{N} [ \begin{matrix}{a}_{x , i} \\ {a}_{y , i} \\ {a}_{z , i}\end{matrix} ] & [ Equation 6 ] \\ {Cov}_{3 * 3} = \frac{1}{N} {\sum }_{i = 1}^{N} ( [ \begin{matrix}{a}_{x , i} \\ {a}_{y , i} \\ {a}_{z , i}\end{matrix} ] - [ \begin{matrix}{μ}_{x} \\ {μ}_{y} \\ {μ}_{z}\end{matrix} ] ) {( [ \begin{matrix}{a}_{x , i} \\ {a}_{y , i} \\ {a}_{z , i}\end{matrix} ] - [ \begin{matrix}{μ}_{x} \\ {μ}_{y} \\ {μ}_{z}\end{matrix} ] )}^{T} & \end{matrix}$$

Further, in Equation 6, μ and Cov_{3*3} represent matrices of average and covariance for a plurality of 3-dimensional data, respectively. Σ is a 3×3 diagonal matrix, and the diagonal component means an eigenvalue. In addition, e1 means a direction with the largest variance, e2 means a direction perpendicular to e1 and having the next largest variance, and e3 means a direction perpendicular to e1 and e2 and having the next largest variance.

Meanwhile, as described above, in S260 of FIG. 7, some of the plurality of data are removed as noise. Specifically, in one embodiment, data separated from the e1 vector by more than a threshold is regarded as noise and removed. To this end, a method for removing data using Equations 7 and 8 is proposed.

d1 in Equation 7 means a Mahalanobis Distance generally used to obtain a 3-demensional distance based on probability, and 3-demensional data having a threshold value or more is regarded as noise and removed. d2 in Equation 8 means a Mahalanobis Distance for obtaining a vertical distance between the red line in FIG. 10 (same as a direction of an e1 vector) and the 3-demensional data based on probability, and 3-demensional data having a threshold value or more is regarded as noise and removed.

d₁=\sqrt{(αᵢ−μ)^{T}Cov_{3*3}⁻¹(αᵢ−μ)} [Equation 7]

Here, ai=[a_{x,i}, a_{y,i}, a_{z,i}] means the data measured by the i^{th} acceleration sensor at 3 axes.

$$\begin{matrix}{d}_{2} = \sqrt{{p}_{i}^{T} {Cov}_{2 * 2}^{- 1} {p}_{i}} & [ Equation 8 ] \\ {p}_{i} = [ \begin{matrix}{p}_{x , i} \\ {p}_{y , i}\end{matrix} ] = [ \begin{matrix}{e}_{2} ( {a}_{i} - μ ) \\ {e}_{3} ( {a}_{i} - μ )\end{matrix} ] & \end{matrix}$$

Here, pi means a x-y coordinate projecting ai into a two-dimensional coordinate system consisting of e2 vector and e3 vector, Cov_{2*2} is a 2×2 diagonal matrix, and is obtained using the (2,2) and (3,3) values among the diagonal components of Cov_{3*3}.

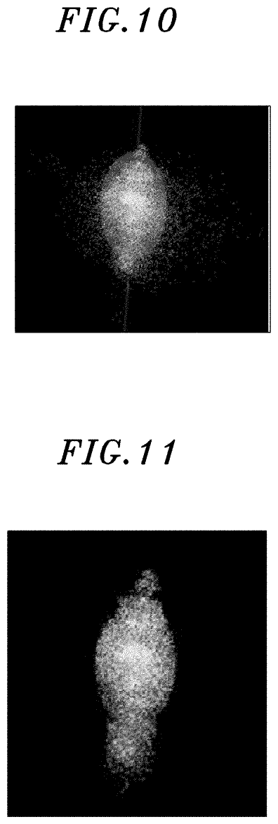

FIG. 11 shows that noise is removed from the data of FIG. 8 by applying equations 7 and 8.

Meanwhile, at S270 of FIG. 7, when data corresponding to noise is removed at S260, the principal component vector is recalculated based on the remaining data excluding the data removed as noise among the plurality of data (S270).

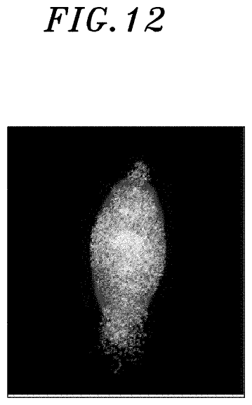

Specifically, covariance is calculated for the remaining data excluding the data removed as noise among the plurality of data; PCA is performed again based on the covariance; and as a result, an e1 vector, which is the principal component vector representing a direction having the greatest variance, is derived again. The e1 vector means a direction vector parallel to an x-z plane of a vehicle coordinate system on the basis of an inertial measuring unit coordinate system, and is defined as V_{xz}. Here, FIG. 12 shows the covariance obtained from the remaining data from which noise has been removed.

Next, at S280 of FIG. 7, the principal component vector recalculated at S270 is estimated as a vector parallel to the x-z plane of the vehicle V (S280).

Referring to FIG. 4 again, at S400, a rotation transformation matrix of an inertial measuring unit 300 is calculated based on a vehicle coordinate system (S400). The S400 will be described in more detail with reference to FIG. 13.

FIG. 13 is a more detailed flowchart of S400 shown in FIG. 4. Referring to FIG. 13, first, a moving direction vector of the vehicle V is estimated based on the height direction vector estimated at S100 of FIG. 4 and the width direction vector estimated at S300 of FIG. 4 (S410).

In addition, based on the moving direction vector estimated at S410, the width direction vector estimated at S300 and the height direction vector estimated at S100, a rotation transformation matrix for an attitude angle of the vehicle V is calculated on the basis of a coordinate system of the inertial measuring unit 300 (S420).

Further, an inverse matrix of the rotation transformation matrix calculated at S420 is calculated as the rotation transformation matrix of the inertial measuring unit 300 (S430).

These steps S410 to S430 are shown in Equation 9 below.

V_{y}=V_{z}×V_{xz}

Vₓ=V_{y}×V_{z}

R_{I2V}=[VₓV_{y}V_{z}] [Equation 9]

Here, the symbol ‘x’ may mean a cross product between two vectors, and each of the vector Vₓ, the vector V_{y} and the vector V_{z} is obtained through the cross product between the given vectors, and may be expressed as a unit vector. In one embodiment, a rotation transformation matrix R_{V2I} representing an attitude angle of the inertial measuring unit 300 on the basis of a vehicle coordinate system to be finally obtained becomes an inverse matrix of R_{I2V}.

On the other hand, when the vehicle V is driven for a long time, a rotation transformation matrix {R_{V2I,1}, . . . , R_{V2I,k}} representing the attitude angles of the inertial measuring unit 300 on the basis of a plurality of vehicle coordinate system can be obtained naturally at various places through the above calibration process.

Accordingly, in one embodiment, each of the rotation transformation matrices is expressed as a quaternion, and an average of the quaternions is calculated so as to express a plurality of quaternions as a single quaternion, and then, it can be expressed again as the rotation transformation matrix R_{I2V}. If a plurality of rotation transformation matrices are simply averaged and expressed as one rotation transformation matrix, the orthogonal matrix form, which is a characteristic of the rotation transformation matrix, cannot be guaranteed, and therefore, the quaternion is used as described above. The final rotation transformation matrix R_{V2I} is obtained by using only rotation transformation matrices representing the attitude angles of the most recently obtained k inertial measuring units on the basis of the vehicle coordinate system, whereby the accuracy increases, and the rotation transformation matrices obtained long ago are naturally eliminated. By performing this process, the accuracy of the rotation transformation matrix between the vehicle coordinate system and the inertial measuring unit coordinate system can be greatly improved.

In addition, in one embodiment, a condition of a flat ground is assumed to estimate a Z-axis direction of the vehicle V on the basis of an inertial measuring unit coordinate system, but it is not easy to determine the condition of a flat ground by a human eye. In order to solve this problem, in one embodiment, a Z-axis direction of the vehicle on the basis of the inertial measuring unit 300 coordinate system is estimated at various places considered to be the flat ground conditions, and the final rotation transformation matrix R_{V2I} is obtained by the above calibration method, whereby it is possible to reduce errors caused by determining the flat ground conditions.

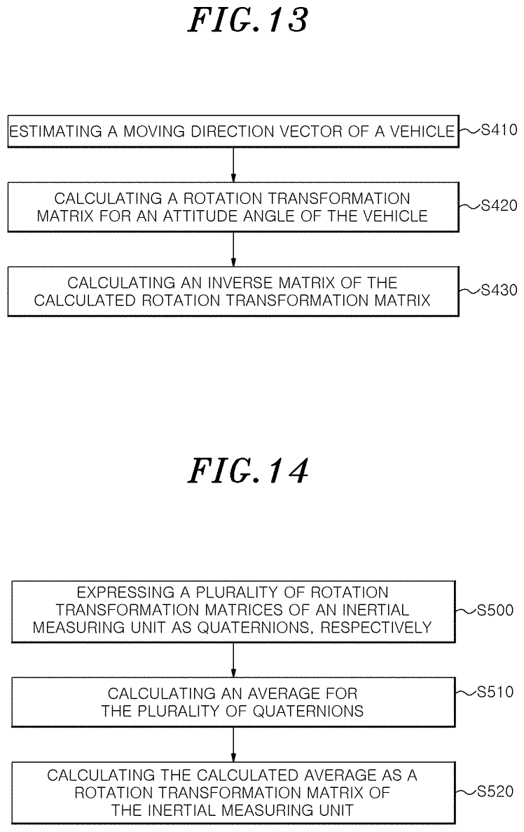

FIG. 14 shows the step of expressing a plurality of rotation transformation matrices as quaternions, respectively (S500), the step of calculating an average for the plurality of quaternions (S510), and the step of calculating the average calculated at S510 as a rotation transformation matrix of the inertial measuring unit 300 (S520).

As described above, according to one embodiment, the calibration apparatus 100 can calibrate the inertial measuring unit 300 in an online manner without a separate external apparatus in an environment in which the vehicle V actually runs on a road. Accordingly, it is possible to simplify and reduce a calibration process for an ADAS applying the inertial measuring unit 300 and an autonomous vehicle.

And also, according to an embodiment, when a rotation transformation matrix indicating a mounting angle of an inertial measuring unit on the basis of a vehicle coordinate system is obtained, fusion between an in-vehicle sensor and an IMU sensor is possible, thereby improving an estimation performance of not only ADAS but also autonomous vehicle's own position as well as surrounding object position.

Meanwhile, each step included in the calibration method according to an embodiment may be implemented in a computer-readable recording medium recording a computer program programmed to perform such steps.

On the other hand, each step included in the calibration method according to the embodiment as described above may be implemented in a computer-readable recording medium recording a computer program programmed to perform such steps.

The above description is merely illustrative of the technical idea of the present disclosure, and various modifications and variations can be made by those skilled in the art to which the present disclosure pertains without departing from the essential quality of the present disclosure. Therefore, the embodiments disclosed herein are not intended to limit the technical spirit of the present disclosure, but to illustrate it, and the scope of the technical spirit of the present disclosure is not limited by these embodiments. The protection scope of the present disclosure should be interpreted by the following claims, and all technical ideas within the scope equivalent thereto should be interpreted as being included in the scope of the present disclosure.

What is claimed is:

1. A method for calibrating an inertial measuring unit (IMU), the method comprising:
estimating a height direction vector of a vehicle based on data measured, while the vehicle is stopped, by the inertial measuring unit mounted on the vehicle;
estimating a vector parallel to a plane including a moving direction vector and the estimated height direction vector of the vehicle based on data measured, while the vehicle is moving straight, by the inertial measuring unit;
estimating a width direction vector of the vehicle based on the estimated height direction vector and the vector estimated to be parallel to the plane; and
calculating a rotation transformation matrix of the inertial measuring unit on the basis of a coordinate system of the vehicle, using the estimated height direction vector and the estimated width direction vector.

2. The method of claim 1, wherein the estimating the height direction vector comprises:
defining a vector based on data measured at each of three axes by an acceleration sensor included in the inertial measuring unit; and
estimating a direction opposite to the direction of the defined vector as a direction indicated by the height direction vector.

3. The method of claim 1, wherein the estimating a vector parallel to the plane comprises:
estimating whether the vehicle is moving straight or not based on data measured by a gyroscope included in the inertial measuring unit.

4. The method of claim 3, wherein the estimating whether the vehicle is moving straight or not comprises:
defining a vector based on the data measured at each of the three axes by the gyroscope;
calculating a rotation angular velocity of the vehicle on the basis of the height direction, based on the defined vector; and
estimating whether the vehicle is moving straight or not based on the calculated rotation angular velocity.

5. The method of claim 4, wherein the estimating whether the vehicle is moving straight or not based on the calculated rotation angular speed comprises,
estimating that the vehicle is moving straight when an absolute value of the calculated rotation angular velocity is equal to or less than a predetermined threshold.

6. The method of claim 1, wherein the estimating a vector parallel to the plane comprises:
calculating an average and a covariance for a plurality of data measured by an acceleration sensor included in the inertial measuring unit;
calculating a principal component vector for the plurality of data based on the average and the covariance;
removing data corresponding to noise from the plurality of data based on the calculated principal component vector;
recalculating the principal component vector for the remaining data excluding the data corresponding to noise among the plurality of data; and
estimating the recalculated principal component vector as the vector parallel to the plane.

7. The method of claim 6, wherein the calculating the principal component vector or the recalculating the principal component vector is performed using a principal component analysis (PCA) algorithm.

8. The method of claim 6, wherein the removing the data corresponding to the noise comprises
calculating a Mahalanobis Distance of the calculated principal component vector to each of the plurality of data;
selecting data corresponding to the noise from the plurality of data based on the calculated Mahalanobis Distance; and
removing the selected data.

9. The method of claim 1, wherein the calculating the rotation transformation matrix of the inertial measuring unit comprises:
estimating a moving direction vector of the vehicle based on the estimated height direction vector and the estimated width direction vector,
calculating a rotation transformation matrix for an attitude angle of the vehicle on the basis of the coordinate system of the inertial measuring unit, based on the estimated height direction vector, the estimated width direction vector and the estimated moving direction vector, and
calculating an inverse matrix of the rotation transformation matrix for the attitude angle of the vehicle as the rotation transformation matrix of the inertial measuring unit.

10. The method of claim 1, wherein the estimating the height direction vector, the estimating the vector parallel to the plane, the estimating the width direction vector and the calculating the rotation transformation matrix are performed multiple times while the vehicle is moving, and
wherein the method further comprises:
expressing each of a plurality of rotation transformation matrices of the inertial measuring units, which are calculated from the multiple times performed method, as quaternion;
calculating an average for the plurality of quaternions; and
calculating the calculated average as a rotation transformation matrix of the inertial measuring unit.

11. A non-transitory computer-readable storage medium including computer executable instructions, wherein the instructions, when executed by a processor, cause the processor to perform a method of calibrating an inertial measuring unit (IMU), the method comprising:
estimating a height direction vector of a vehicle based on data measured, while the vehicle is stopped, by the inertial measuring unit mounted on the vehicle;
estimating a vector parallel to a plane including a moving direction vector and the estimated height direction vector of the vehicle based on data measured, while the vehicle is moving straight, by the inertial measuring unit;
estimating a width direction vector of the vehicle based on the estimated height direction vector and the vector estimated to be parallel to the plane; and
calculating a rotation transformation matrix of the inertial measuring unit on the basis of a coordinate system of the vehicle, using the estimated height direction vector and the estimated width direction vector.

12. A calibration apparatus for calibrating an inertial measuring unit (IMU) mounted on a vehicle, the calibration apparatus comprises:
a processor; and
a memory storing computer executable instructions, the instructions when executed by the processor cause the processor to:
estimate a height direction vector of the vehicle based on data measured, while the vehicle is stopped, by the inertial measuring unit,
estimate a vector parallel to a plane including a moving direction vector and the estimated height direction vector of the vehicle based on data measured, while the vehicle is moving straight, by the inertial measuring unit,
estimate a width direction vector of the vehicle based on the estimated height direction vector and the vector estimated to be parallel to the plane, and
calculate a rotation transformation matrix of the inertial measuring unit on the basis of a coordinate system of the vehicle, using the estimated height direction vector and the estimated width direction vector.

13. The calibration apparatus of claim 12, wherein the instructions further cause the processor to:
define a vector based on data measured at each of three axes by an acceleration sensor included in the inertial measuring unit, and
estimate a direction opposite to the direction of the defined vector as a direction indicated by the height direction vector.

14. The calibration apparatus of claim 12, wherein the instructions further cause the processor to estimate whether the vehicle is moving straight or not based on data measured by a gyroscope included in the inertial measuring unit.

15. The calibration apparatus of claim 14, wherein the instructions further cause the processor to:
define a vector based on data measured at each of the three axes by the gyroscope,
calculate a rotation angular velocity of the vehicle on the basis of the height direction based on the defined vector, and
estimate whether the vehicle is moving straight or not based on the calculated rotation angular velocity.

16. The calibration apparatus of claim 15, wherein the instructions further cause the processor is to estimate that the vehicle is moving straight when an absolute value of the calculated rotation angular velocity is equal to or less than a predetermined threshold.

17. The calibration apparatus of claim 12, wherein the instructions further cause the processor to:
calculate an average and a covariance for a plurality of data measured by an acceleration sensor included in the inertial measuring unit,
calculate a principal component vector for the plurality of data based on the average and the covariance,
remove data corresponding to a noise from the plurality of data based on the calculated principal component vector,
recalculate the principal component vector for the remaining data excluding the data corresponding to the noise among the plurality of data, and
estimate the recalculated principal component vector as the vector parallel to the plane.

18. The calibration apparatus of claim 17, wherein the instructions further cause the processor to:
calculate a Mahalanobis Distance of the calculated principal component vector to each of the plurality of data, and
select data corresponding to the noise from the plurality of data based on the calculated Mahalanobis Distance, and then remove the selected data.

19. The calibration apparatus of claim 12, wherein the instructions further cause the processor to:
estimate a moving direction vector of the vehicle based on the estimated height direction vector and the estimated width direction vector,
calculate a rotation transformation matrix for an attitude angle of the vehicle on the basis of a coordinate system of the inertial measuring unit, based on the estimated height direction vector, the estimated width direction vector and the estimated moving direction vector, and
calculate an inverse matrix of the rotation transformation matrix for the attitude angle of the vehicle as a rotation transformation matrix of the inertial measuring unit.

20. The calibration apparatus of claim 12, wherein the instructions further cause the processor to:
perform the estimation of the height direction vector of the vehicle, the estimation of the vector parallel to the plane, the estimation of the width-direction vector of the vehicle and the calculation of the rotation transformation matrix of the inertial measuring unit multiple times while the vehicle is moving,
express each of a plurality of rotation transformation matrices of the inertial measuring units, which are calculated from the multiple times performed execution, as quaternion,
calculate an average for the plurality of quaternions, and
calculate the calculated average as a rotation transformation matrix of the inertial measuring unit.
